(19) United States
(12) Patent Application Publication
(10) Pub. No.: US 2023/0296278 A1
(43) Pub. Date: Sep. 21, 2023

(54) AIR-CONDITIONING CONTROL DEVICE

(71) Applicant: Mitsubishi Electric Corporation, Tokyo (JP)

(72) Inventors: Masae SAWADA, Tokyo (JP); Mio MOTODANI, Tokyo (JP); Ryuta TANAKA, Tokyo (JP)

(73) Assignee: Mitsubishi Electric Corporation, Tokyo (JP)

(21) Appl. No.: 17/909,773

(22) PCT Filed: May 13, 2020
(86) PCT No.: PCT/JP2020/019100

§ 371 Date: Sep. 7, 2022

(51) Int. Cl. F24F 11/63; G05B 19/042

(52) U.S. Cl. CPC F24F 11/63; G05B 19/042; G05B 2219/2614

(57) ABSTRACT

An air-conditioning control device includes an evaluation unit configured to receive inputs of package management data, air-conditioning apparatus operation data, and sensor measurement data that are received by a receiver device, an input of package placement determined by a package placement determination unit, and an input of an air-conditioning operation state of an air-conditioning apparatus determined by an air-conditioning operation determination unit, calculate as an evaluation value at least one of package temperature, temperature at a plurality of points in an indoor space, and electricity consumption of the air-conditioning apparatus by using a package model, an environmental distribution model, and an air-conditioning apparatus model that are stored in a storage device, and determine an optimum air conditioning operation state and an optimum package placement.

### TECHNICAL FIELD

The present disclosure relates to an air-conditioning control device to control an air-conditioning apparatus that conditions air in an indoor space where packages are stored.

### BACKGROUND ART

Cold storage warehouses configured to keep articles such as foods require strict temperature control due to the necessity of preventing deterioration of the quality of the articles. It is, however, difficult to maintain a uniform temperature in a warehouse because of the temperature distribution in the space of the warehouse. The temperature distribution is affected by, for example, heat inflow from wall and ceiling surfaces, loads for cooling articles newly stored in the warehouse, and outside air inflow when an entrance is opened or closed. Thus, in order to maintain the entire warehouse at or below a particular temperature, the warehouse needs to be cooled more than necessary by lowering the set temperature for air conditioning. As a result, a problem arises that energy for air conditioning is inefficiently consumed.

In Patent Literature 1 the space in a warehouse is sectioned so as to include multiple spaces; and for each space section, temperature and humidity in a future period are estimated. Further, in Patent Literature 1, referring to, for example, information about temperature and humidity suitable for maintenance of individual articles and information about volume of individual articles, which are managed in a database, when the estimated values of temperature and humidity in the space section are determined to exceed the temperature and humidity suitable for maintenance of an article, a space section satisfying the condition of maintenance temperature and humidity is searched for, and the article is repositioned to the discovered space section.

### CITATION LIST

### Patent Literature

Patent Literature 1: Japanese Unexamined Patent Application Publication No. 2019-14551

### SUMMARY OF INVENTION

### Technical Problem

However, in the method disclosed in Patent Literature 1, articles are determined to be re-positioned only based on whether the estimated values of temperature and humidity in the space sections are below the temperature and humidity suitable for maintenance of the articles. Patent Literature 1 does not consider other indicators such as work efficiency in the warehouse, and additionally, Patent Literature 1 does not describe any specific method for controlling an air-conditioning apparatus.

Further, in the method for estimating temperature and humidity in each space section according to Patent Literature 1, the estimated values of temperature and humidity are calculated based on environmental factors such as the operating condition of air conditioning and the distance from an entrance. Patent Literature 1 does not consider heat transfer between space sections or air transfer due to repositioning of packages. Consequently, in Patent Literature 1, it is unable to estimate changes in temperature in the warehouse with time under the effect of heat released from articles shortly after being stored in the warehouse and air flow of air conditioning. For these reasons, there is possibility that Patent Literature 1 does not provide air conditioning with optimized article placement and optimized control of air conditioning.

The present disclosure has been made to solve this problem, and an object thereof is to implement an air-conditioning control device that can optimize both placement of packages stored in an indoor space and control of air conditioning.

### Solution to Problem

An air-conditioning control device according to an embodiment of the present disclosure, which is configured to control an air-conditioning apparatus conditioning air in an indoor space where a package is stored, includes a receiver device configured to receive package management data including item information of the package, air-conditioning apparatus operation data including a set temperature of the air-conditioning apparatus, and sensor measurement data including a temperature in the indoor space, the temperature in the indoor space being measured by a sensor installed in the indoor space, a package placement determination unit configured to determine a package placement of the package based on the package management data received by the receiver device, an air-conditioning operation determination unit configured to determine an air-conditioning operation state of the air-conditioning apparatus based on the package placement determined by the package placement determination unit, the air-conditioning operation state including either one of the set temperature of the air-conditioning apparatus and an evaporating temperature in a refrigeration cycle that is set on the air-conditioning apparatus, a storage device configured to store a package model for estimating a package temperature of the package based on the package management data, an environmental distribution model for estimating, with respect to a plurality of points in the indoor space, a temperature at each point of the plurality of points based on the package placement determined by the package placement determination unit, the air-conditioning operation state determined by the air-conditioning operation determination unit, and the air-conditioning apparatus operation data and the sensor measurement data that are received by the receiver device, and an air-conditioning apparatus model for estimating electricity consumption of the air-conditioning apparatus based on the air-conditioning operation state determined by the air-conditioning operation determination unit, an evaluation unit configured to receive inputs of the package management data, the air-conditioning apparatus operation data, and the sensor measurement data that are received by the receiver device, an input of the package placement determined by the package placement determination unit, and an input of the air-conditioning operation state of the air-conditioning apparatus determined by the air-conditioning operation determination unit, calculate as an evaluation value at least one of the package temperature, the temperature at each point of the plurality of points in the indoor space, and the electricity consumption of the air-conditioning apparatus by using the package model, the environmental distribution model, and the air-conditioning apparatus model that are stored in the storage device, and determine an optimum air-conditioning operation state and an optimum package placement, a control instruction conversion unit configured to convert the optimum air-conditioning operation state determined by the evaluation unit into a control instruction to be provided for the air-conditioning apparatus, a transmitter device configured to transmit the control instruction to the air-conditioning apparatus, and a display device configured to display the optimum package placement determined by the evaluation unit. The evaluation unit is configured to, while changing based on the calculated evaluation value one or both of the package placement and the air-conditioning operation state respectively determined by the package placement determination unit and the air-conditioning operation determination unit, repeatedly calculate the evaluation value a preset number of times, and determine the air-conditioning operation state and the package placement when the evaluation value is a greatest value of evaluation values of the preset number of times to be the optimum air-conditioning operation state and the optimum package placement.

### Advantageous Effects of Invention

The air-conditioning control device according to an embodiment of the present disclosure selects an optimum package placement and an optimum air-conditioning operation state by repeatedly calculating the evaluation value with the package model, the environmental distribution model, and the air-conditioning apparatus model, and as a result, placement of the package stored in the indoor space and air conditioning control can be both optimized.

### BRIEF DESCRIPTION OF DRAWINGS

FIG. 1 is a diagram illustrating an example of an air-conditioning system including an air-conditioning control device 1 according to Embodiment 1.

FIG. 2 is a block diagram illustrating an example of a configuration of the air-conditioning control device 1 according to Embodiment 1.

FIG. 3 illustrates an indoor space 6 according to Embodiment 1 that is divided into three in the height direction (X direction) so that three regions 6a are provided.

FIG. 4 illustrates the indoor space 6 according to Embodiment 1 that is divided into three in the height direction (X direction) and five in the depth direction (Z direction) so that fifteen regions 6a are provided.

FIG. 5 illustrates an example of a package thermal characteristic table 142 of the air-conditioning control device 1 according to Embodiment 1.

FIG. 6 illustrates an example of package management data 144a of he air-conditioning control device 1 according to Embodiment 1.

FIG. 7 illustrates an example of air-conditioning apparatus operation data air-conditioning control device 1 according to Embodiment 1.

FIG. 8 illustrates an example of space characteristic information 141 of the air-conditioning control device 1 according to Embodiment 1.

FIG. 9 is a flowchart illustrating a flow of a process performed by a package placement determination unit 152a of the air-conditioning control device 1 according to Embodiment 1.

FIG. 10 is a flowchart illustrating a flow of a process performed by the package placement determination unit 152a of the air-conditioning control device 1 according to Embodiment 1.

### DESCRIPTION OF EMBODIMENTS

Hereinafter, an embodiment of an air-conditioning control device according to the present disclosure will be described with reference to the drawings. The present disclosure is not limited to the following embodiment, and various modifications may be made without departing from the spirit and scope of the present disclosure. The present disclosure includes any combinations of combinable configurations described in the following embodiment and their modifications. In the drawings, elements assigned the same reference characters are identical to or correspond to each other the same applies to the entire specification. It should be noted that, for example, the relative dimensions or shape of the constituent elements in the drawings may be different from actual ones.

### Embodiment 1

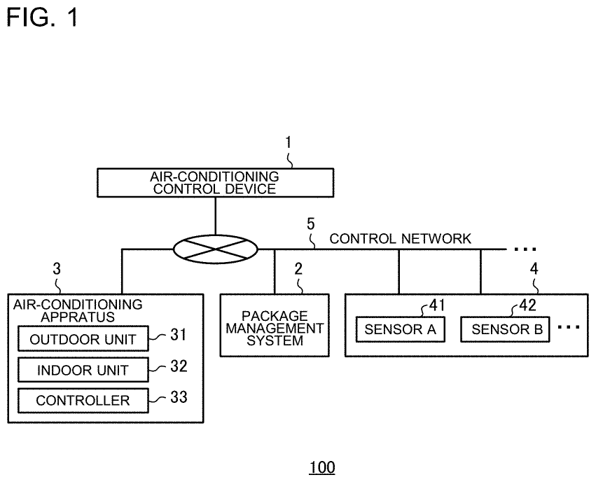

FIG. 1 is a diagram illustrating an example of an air-conditioning system 100 including an air-conditioning control device 1 according to Embodiment 1. As illustrated in FIG. 1, the air-conditioning system 100 includes the air-conditioning control device 1, a package management system 2, an air-conditioning apparatus 3, and a sensor 4. The air-conditioning control device 1 is communicably connected to the package management system 2, the air-conditioning apparatus 3, and the sensor 4 through a control network 5.

### (Air-Conditioning, Control Device 1)

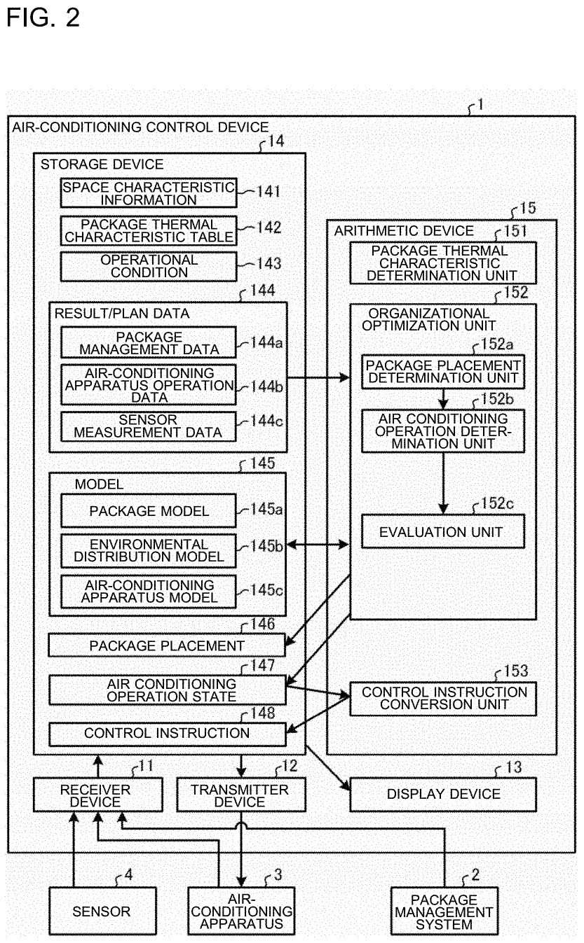

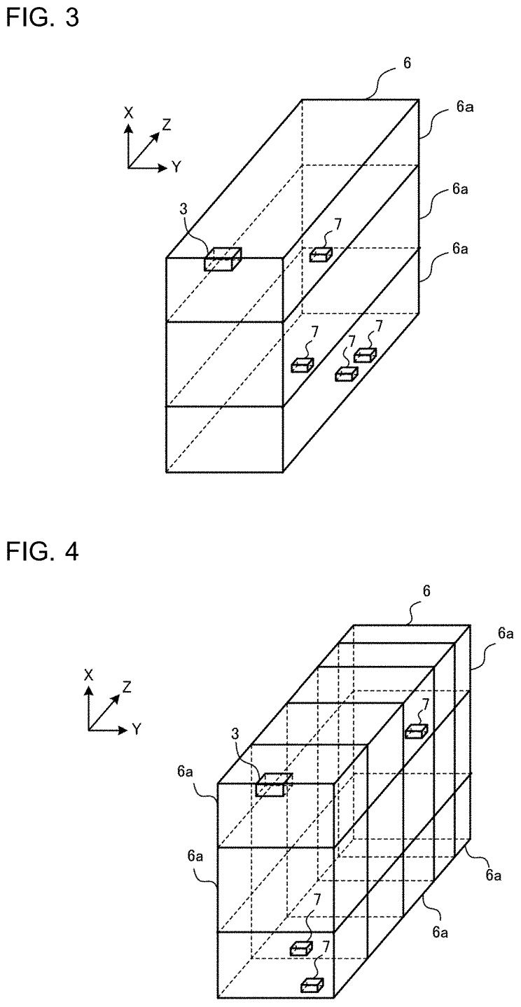

Through the control network 5, the air-conditioning control device 1 receives sensor measurement data 144c (refer to FIG. 2) from the sensor 4, accordingly controls the air-conditioning apparatus 3, and transmits information to the package management system 2. The air-conditioning control device 1 controls air conditioning in an indoor space 6 (refer to FIG. 3 or 4) of a building such as a warehouse for storing packages 7 (refer to FIG. 3 or 4). The air-conditioning apparatus 3 is installed in the indoor space 6. In Embodiment 1,the warehouse may be, for example, a cold storage warehouse or freezer warehouse. As illustrated in FIG. 3 or 4, the indoor space 6 may be divided into one or more regions 6a (refer to FIG. 3 or 4), FIG. 3 illustrates the indoor space 6 according to Embodiment 1 that is divided into three in the height direction (X direction) so that three regions 6a are provided. FIG. 4 illustrates the indoor space 6 according to Embodiment 1 that is divided into three in the height direction (X direction) and five in the depth direction (Z direction) so that fifteen regions 6a are provided. One region 6a may accommodate one package 7. Alternatively, one region 6a may accommodate a plurality of packages 7.

As illustrated in FIG. 2, an organizational optimization unit 152 is provided in the air-conditioning control device 1. In the organizational optimization unit 152, a package placement determination unit 152a determines a package placement 146 of the package 7 in the indoor space 6, and an air-conditioning operation determination unit 152b determines an air-conditioning operation state 147 of the air-conditioning apparatus 3. The air-conditioning operation state 147 includes, for example, a set temperature of the air-conditioning apparatus 3. Subsequently, an evaluation unit 152c conducts a simulation with the determined package placement 146 and the determined air-conditioning operation state 147 by using a package model 145a, an environmental distribution model 145b, and an air-conditioning apparatus model 145c and accordingly calculates evaluation values. The evaluation values may indicate, for example, a package temperature of the package 7, a temperature of each region 6a of the indoor space 6, and electricity consumption of the air-conditioning apparatus 3. The organizational optimization unit 152 repeats the simulation multiple times while changing the package placement 146 and the air-conditioning operation state state 147 with regard to these evaluation values. The organizational optimization unit 152 determines as an optimum air-conditioning operation state and an optimum package placement the air-conditioning operation state 147 and the package placement 146 with the greatest evaluation values of the evaluation values obtained by the simulation conducted multiple times. In the following, conducting this simulation will be referred to as a “trial”. Details of the organizational optimization unit 152 will be described later.

### (Package Management System 2)

Referring back to FIG. 1, the package management system 2 is a system for managing information about the package 7 stored in the indoor space 6, which may be, for example, a cold storage warehouse. A bar code, or an attachment such as a radio frequency identifier (RFID) tag is attached to the package 7. The attachment includes identification information assigned to each package 7. In the following, the identification information is referred to as a package ID. The package management system 2 has a memory to store, for each package ID, the following information. Specifically, the memory stores information such as present placement location information of the package 7, information about warehouse entry date and time and warehouse exit date and time of the package 7, package item information indicating contents of the package 7, information about the size of the package 7 such as width, depth, and height, and information on temperature and humidity ranges suitable to keep the package 7. Based on these kinds of information, the package management system 2 provides assistance for management of package inventory and logistics. The components of the package management system 2 and the information managed by the package management system 2 are merely an example, and these are not restrictive. The package management system 2 may include, for example, a processor and a memory: the functions of the package management system 2 are implemented by running a program stored in the memory.

### (Air-Conditioning Apparatus 3)

The air-conditioning apparatus 3 includes an outdoor unit 31, an indoor unit 32, and a controller 33. The outdoor unit 31 cools or heats refrigerant or a heat medium such as water. The indoor unit 32 exchanges heat between air in the indoor space 6 and a heat medium flowing in the indoor unit 32 to control the temperature in the indoor space 6. The controller 33 is a device used by a user to manually turn on or off the indoor unit 32, or select or change settings including the set temperature and the airflow volume of the indoor unit 32. The user may be, for example, an administrator of the warehouse. In the air-conditioning apparatus 3, the outdoor unit 31 and the indoor unit 32 are connected to each other by refrigerant pipes to form a refrigeration cycle.

In Embodiment 1, the indoor space 6 targeted for air conditioning may be, as described above, for example, a space inside a warehouse such as a cold storage warehouse or freezer warehouse. Depending on the scale of the indoor space 6, the number of the indoor units 32 installed in the single indoor space 6 alters. This means that a single indoor unit 32 may be installed in the single indoor space 6; or a plurality of indoor units 32 may be installed in the single indoor space 6. In the air-conditioning apparatus 3, a single indoor unit 32 may be connected to a single outdoor unit 31; otherwise a plurality of indoor units 32 may be connected to a single outdoor unit 31.

The packages 7 stored in the indoor space 6 are articles with the necessity of temperature control, such as foods, chemicals, and servers. These are merely examples, and the type and shape of the indoor space 6, the type and configuration of the air-conditioning apparatus 3, the item of the package 7, and other specifics are not limited to these examples.

### (Sensor 4)

The sensor 4 is a sensor for measuring physical quantities and composed of one or a plurality of sensors including a sensor a (reference numeral 41), a sensor b (reference numeral 42), and other sensors, The sensor 4 obtains data of indoor and outdoor environmental conditions and outputs the obtained data as the sensor measurement data 144c (refer to FIG. 2). The sensor 4 is a sensor for measuring or obtaining, for example, temperature, humidity, radiation temperature, thermal images, and airstream velocity. When the air-conditioning apparatus 3 includes a sensor, the sensor in the air-conditioning apparatus 3 may be used as the sensor 4. A sensor included in the outdoor unit 31 of the air-conditioning apparatus 3 may be used as the sensor 4 to measure outdoor temperature. Alternatively, for example, information on weather forecasts obtained through the Internet may be used as the sensor measurement data 144c of the sensor 4 The sensor 4 may include a camera for obtaining geometric information of the indoor space 6.

### (Control Network 5)

The control network 5 is a communication network connecting the air-conditioning control device 1, the package management system 2, the air-conditioning apparatus 3, and the sensor 4. In the control network 5, for example, the cable type and the communications protocol are not limited to any particular cable type and any particular communications protocol. For example, the control network 5 may be a wired network such as a local area network (LAN), or a wireless network. The control network 5 may be a network using a publicly available general protocol. The control network 5 may be dedicated lines of a manufacturer of the air-conditioning apparatus 3; in this case, for example, a dedicated protocol may be used. The control network 5 may be Internet lines.

### (Configuration of Air-Conditioning Control Device 1)

FIG. 2 is a block diagram illustrating an example of a configuration of the air-conditioning control device 1 according to Embodiment 1. The following describes a configuration of the air-conditioning control device 1 with reference to FIGS. 1 and 2. The functions of the air-conditioning control device 1 illustrated in FIGS. 1 and 2 are implemented by a processor, which is provided in, for example, a microcomputer or computer, running a program stored in a storage device 14 such as a magnetic disk or semiconductor memory, The air-conditioning control device 1 illustrated in FIG. 2, which controls operations of the air-conditioning apparatus 3 as described above, includes the storage device 14, an arithmetic device 15, a receiver device 11, a transmitter device 12, and a display device 13.

### (Receiver Device 11)

The receiver device 11 obtains data from the air-conditioning apparatus 3 and the sensor 4 on a preset cycle and stores the data in the storage device 14. The cycle of obtaining data may be, but not limited to, for example, five minutes. The cycle of obtaining data from the air-conditioning apparatus 3 and the cycle of obtaining data from the sensor 4 may be different from each other. The following describes data obtained from the air-conditioning apparatus 3 and data obtained from the sensor 4.

The receiver device 11 receives from the air-conditioning apparatus 3 air-conditioning apparatus operation data 144b including information about the set temperature of the air-conditioning apparatus 3. The air-conditioning apparatus operation data 144b includes, as illustrated in FIG. 7, data of set temperature and data of airflow volume of the air-conditioning apparatus 3 for each air-conditioning apparatus ID. Here, the air-conditioning apparatus ID is identification information assigned to each individual air-conditioning apparatus 3. FIG. 7 illustrates an example of the air-conditioning apparatus operation data 144b of the air-conditioning control device 1 according to Embodiment 1. The air-conditioning apparatus operation data 144b may include, as well as the kinds of data indicated in FIG. 7, data of set humidity, airflow volume, airflow velocity, and airflow direction of the air-conditioning apparatus 3. The air-conditioning apparatus operation data 144b may also include information measured by the individual units of the air-conditioning apparatus 3 to use for control; the information may be, for example, room temperature, outside-air temperature, refrigerant temperature, and flow rate.

The receiver device 11 receives from the sensor 4 the sensor measurement data 144c including the temperature in the indoor space 6, measured by the sensor 4. The sensor measurement data 144c may also include, for example, outdoor temperature, indoor and outdoor humidity levels, radiation temperature, thermal images, and airstream velocity.

The receiver device 11 also receives package management data 144a including the item information of the package 7 from the package management system 2 and stores the package management data 144a in the storage device 14. The package management data 144a includes, as indicated in FIG. 6, warehouse entry date and time and warehouse exit due date and time of the package 7, package item information indicating contents of the package 7, volume of the package 7, and maintenance temperature of the package 7, for each package ID. FIG. 6 illustrates an example of the package management data 144a of the air-conditioning control device 1 according to Embodiment 1. The package management data 144a does not necessarily include all kinds of data indicated in FIG. 6; the package management data 144a only needs to include at least one of the kinds of data. Here, the maintenance temperature of the package 7 indicates an upper limit temperature in the environment around the package 7. For example, when it is required to keep the package 7 at or below 10 degrees C., the maintenance temperature of the packages 7 is “10 degrees C”.

### (Transmitter Device 12)

The transmitter device 12 transmits to the air-conditioning apparatus 3 a control instruction 148 for specifying an optimum air-conditioning operation state determined by the air-conditioning control device 1. The control instruction 148 is generated by a control instruction conversion unit 153.

### (Display Device 13)

The display device 13 displays the optimum package placement 146 determined by the air-conditioning control device 1 to instruct the user to reposition the package 7. The display device 13 may be implemented by, for example, a display. The display device 13 may be included in the air-conditioning control device 1 or implemented by a display screen provided in an external computer or a tablet terminal; the display device 13 can be implemented in any manner.

### (Storage Device 14)

The storage device 14 stores space characteristic information 141, a package thermal characteristic table 142, an operational condition 143, result/plan data 144, a model 145, the package placement 146, the air-conditioning operation state 147, and the control instruction 148.

### (Space Characteristic Information 141)

When the indoor space 6 is divided into the plurality of regions 6a as illustrated in FIG. 3 or 4, the space characteristic information 141 includes, as indicated in FIG. 8, information about work efficiency, temperature consistency, and airflow reach level of each region 6a. Each region 6a is assigned a region ID as identification information. FIG. 8 illustrates an example of the space characteristic information 141 of the air-conditioning control device 1 according to Embodiment 1. The space characteristic information 141 includes, as indicated in FIG. 8, a package ID of the package 7 positioned in the region 6a, an air-conditioning apparatus ID of the air-conditioning apparatus 3 installed in the region 6a, and attributes of the region 6a, for each region ID. The attributes may be, for example, work efficiency, temperature consistency, and airflow reach level. The space characteristic information 141 does not necessarily include all kinds of data indicated in FIG. 8, and the space characteristic information 141 only needs to include at least one kind of data. The work efficiency is information indicating the level of accessibility from an entrance of the indoor space 6. When the distance from an entrance is equal to or longer than a threshold, it is considered to have low work efficiency; when the distance from an entrance is shorter than a threshold, it is considered to have high work efficiency. The work efficiency is set to 0 when the work efficiency in the region 6a is low; the work efficiency is set to 1 when the work efficiency in the region 6a is high. Although the work efficiency is classified into two levels in this description, the work efficiency may be classified into three or more levels. The temperature consistency is information indicating the magnitude of changes in temperature. The temperature consistency is set to 0 when the magnitude of changes in temperature in the region 6a is greater than a threshold; the temperature consistency is set to 10 when the magnitude of changes in temperature in the region 6a is smaller than the threshold. Although the temperature consistency is classified into ten levels in this description, the temperature consistency may be classified into any number of levels more than one level. Depending on the number of levels, one or more thresholds are preset. Given that temperature changes when the outside air flows in, a relatively large change in temperature occurs in the region 6a close to the entrance; whereas a relatively small change in temperature occurs in the region 6a far from the entrance. Thus, the level of temperature consistency may be determined based on the distance from the entrance. Alternatively, the level of temperature consistency may be determined based on the sensor measurement data 144c previously obtained. The airflow reach level is information indicating how much the air flow from an air outlet of the air-conditioning apparatus 3 reaches. The airflow reach level is set depending on the distance from the location of the air outlet of the air-conditioning apparatus 3. When the distance from the air outlet to the region 6a is shorter than a threshold, the reachability of air flow is high, and the airflow reach level is set to 100. When the distance from the air outlet to the region 6a is longer than the threshold, the reachability of air flow is low, and the airflow reach level is set to 1. Although the temperature consistency is classified into one hundred levels in this description, the temperature consistency may be classified into any number of levels more than one level Depending on the number of levels, one or more thresholds are preset.

### (Package Thermal Characteristic Table 142)

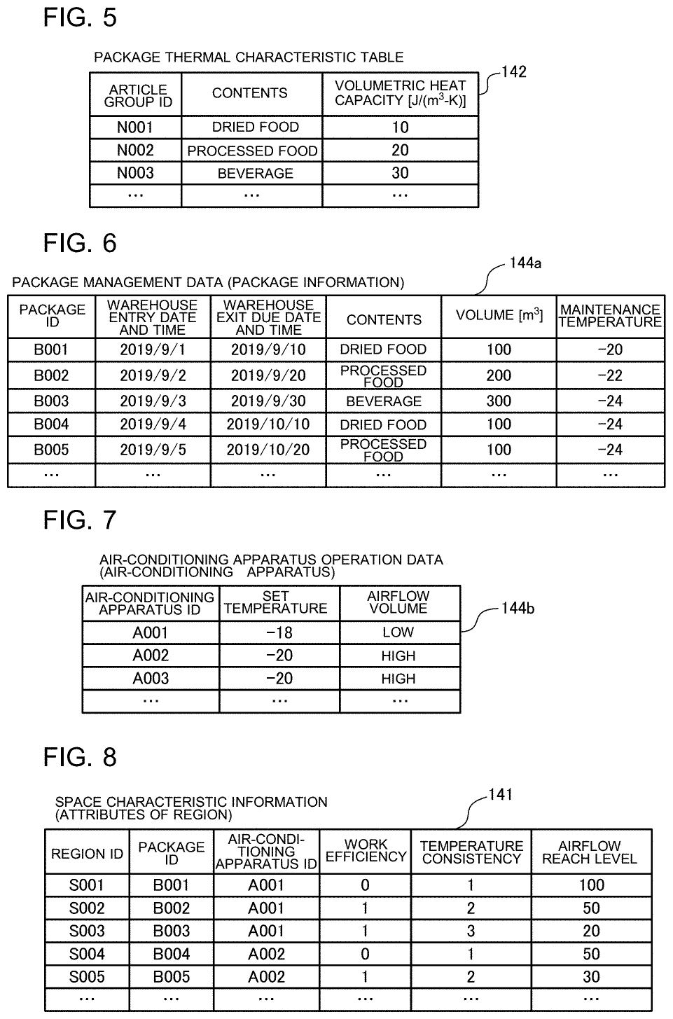

Referring back to FIG. 2, the package thermal characteristic table 142 stores representative heat capacity data of article groups including a plurality of kinds of items of the packages 7. FIG. 5 illustrates an example of the package thermal characteristic table 142 of the air-conditioning control device 1 according to Embodiment 1.As illustrated in FIG. 5, the package thermal characteristic table 142 includes, for each article group ID, item information indicating contents of an article group and information of volume ratio. Here, the article group ID is identification information assigned to each article group. Although the example in FIG. 5 uses information of volumetric heat capacity as heat capacity data, this is not to be interpreted as restrictive. The package thermal characteristic table 142 is used when the arithmetic device 15 of the air-conditioning control device 1 sets parameters appropriate to the package model 145a. Specifically, the arithmetic device 15 searches for an article group of the package 7 based on the item information of the package 7 in the package management data 144a indicated in FIG. 6, then refers to the package thermal characteristic table 142, and accordingly sets parameters appropriate to the package model 145a described later.

### (Operational Condition 143)

Referring back to FIG. 2, the operational condition 143 indicates various conditions necessary in operations of the individual units of the arithmetic device 15.

The operational condition 143 includes, for example, shape of the indoor space 6, information about the regions 6a for storing the packages 7, information about the air-conditioning apparatus 3, and arithmetic operation cycle of the organizational optimization unit 152. which will be described later, of the arithmetic device 15. The information about the air-conditioning apparatus 3 includes, for example, number of the air-conditioning apparatus 3. connections between the indoor unit 32 and the outdoor unit 31, and location of the air outlet of the air-conditioning apparatus 3.

### (Result/Plan Data 144)

The result/plan data 144 includes the package management data 144a indicated in FIG. 6, the air-conditioning apparatus operation data 144b indicated in FIG. 7, and the sensor measurement data 144c. Because these kinds of data have been described above, descriptions thereof are not repeated here.

In the example in FIG. 2, the air-conditioning apparatus operation data 144b and the sensor measurement data 144c are separately provided; but when the air-conditioning apparatus 3 includes the sensor 4 the operation data 144b may include the sensor measurement data 144c obtained by the sensor 4.

### (Model 145)

The model 145 includes the package model 145a, the environmental distribution model 145b, and the air-conditioning apparatus model 145c. The model 145 is used by the evaluation unit 152c of the organizational optimization unit 152.

### (Package Model 145a)

The package model 145a is a model for estimating the package temperature of the package 7 placed in the indoor space 6 based on the package management data 144a. The package model 145a estimates changes in temperature with time for each package 7.

(Environmental distribution model 145b)

The environmental distribution model 145b is a model for estimating temperatures at a plurality of points in the indoor space 6 based on the package placement 146 and the air-conditioning operation state 147. In this description, the environmental distribution model 145b estimates temperatures in the individual regions 6a containing the respective points of the indoor space 6. The environmental distribution model 145b estimates a heating energy environment in the indoor space 6, specified by airflow velocity, temperature, and other conditions with regard to information about each region 6a such as the temperatures of the packages 7 placed in the region 6a and adjacent regions, the air flow from the air outlet of the air-conditioning apparatus 3, and the effect of, for example, incoming air flows from the entrance of the indoor space 6. The environmental distribution model 145b can obtain the temperature distribution of the entire indoor space 6 by estimating temperatures in the individual regions 6a of the indoor space 6.

### (Air-Conditioning Apparatus Model 145c)

The air-conditioning apparatus model 145c is a model for estimating electricity consumption of the air-conditioning apparatus 3 based on the air-conditioning operation state 147. The air-conditioning apparatus model 145c calculates energy necessary for air conditioning based on the environment in the indoor space 6 and the operation state of the air-conditioning apparatus 3.

The evaluation unit 152c described later may provide the estimations while causing the environmental distribution model 145b. the package model 145a, and the air-conditioning apparatus model 145c to mutually exchange the estimation results on a given cycle.

For example, the evaluation unit 152c inputs the package temperature calculated with the package model 145a to the environmental distribution model 145b. The evaluation unit 152c inputs the temperature in each region 6a of the indoor space 6, calculated with the environmental distribution model 145b, to the package model 145a. With this configuration, the evaluation unit 152c can estimate the temperature in each region 6 in a subsequent time step with regard to the package temperature. The evaluation unit 152c in turn can estimate the temperature of the package 7 in a subsequent time step with regard to the temperature in each region 6a and accordingly can determine the placement of the package 7. As a result, it is possible to optimize both package placement and air conditioning control. Furthermore, while maintaining the package 7 within specified temperature and humidity ranges and also securing the work efficiency in the indoor space 6, energy-saving air conditioning control can be realized.

The evaluation unit 152c extracts a temperature at the location of the air inlet of the air-conditioning apparatus 3 from the temperatures in the individual regions 6a of the indoor space 6 calculated with the environmental distribution model 145b. The evaluation unit 152c inputs the extracted temperature to the air-conditioning apparatus model 145c to calculate the temperature of the air outlet of the air-conditioning apparatus 3. The evaluation unit 152c in turn inputs the temperature of the air outlet, of the air-conditioning apparatus 3 calculated with the air-conditioning apparatus model 145c to the environmental distribution model 145b to calculate the temperature at the location of the air inlet of the air-conditioning apparatus 3. With this configuration, a temperature of the air outlet of the air-conditioning apparatus 3 in a subsequent time step can be estimated with regard to the temperature at the location of the air inlet of the air-conditioning apparatus 3; similarly, a temperature at the location of the air inlet of the air-conditioning apparatus 3 in a subsequent time step can be estimated with regard to the temperature of the air outlet of the air-conditioning apparatus 3. As a result, it is possible to optimize both package placement and air conditioning control. Furthermore, while maintaining the package within specified temperature and humidity ranges and also securing the work efficiency in the indoor space 6, energy-saving air conditioning control can be realized.

Further, the air temperature and heat transfer coefficient of heat transferred to the package surfaces calculated with the environmental distribution model 145b may be provided for the package model 145a. With this configuration, the package model 145a can estimate a package temperature in a subsequent time step with regard to the amount of heat released to or received from the surrounding environment.

The evaluation unit 152c may provide the air temperature calculated with the environmental distribution model 145b for the air-conditioning apparatus model 145c. With this configuration, the air-conditioning apparatus model 145c can estimate the temperature of air flow at the air outlet, power, and electricity consumption in a subsequent time step based on the present room temperature. The evaluation unit 152c may convert the power calculated with the air-conditioning apparatus model 145c into the airflow temperature and airflow velocity at the air outlet and provide the airflow temperature and airflow velocity for the environmental distribution model 145b, and the evaluation unit 152c may also provide the package temperature calculated with the package model 145a for the environmental distribution model 145b. With this configuration the effect of package temperature and outflowing air from the air-conditioning apparatus 3 on the heating energy environment of the space can be taken into account.

The environmental distribution model 145b, the package model 145a, and the air-conditioning apparatus model 145c are models based on preset physics equations. The following presents physics equations and describes these models in detail,

### (Specific Example of Environmental Distribution Model 145b)

The environmental distribution model 145b estimates temperature and flow velocity in each region 6a by using computational fluid dynamics (CFD) analysis. For example, the environmental distribution model 145b previously receives an input of geometric information of the indoor space 6, divides the indoor space 6 into the plurality of regions 6a as illustrated in FIGS. 3 or 4, and estimates temperature and airflow velocity in each region 6a by using CFD analysis. The environmental distribution model 145b calculates temperature in each region 6a based on input conditions of the air-conditioning operation state 147 determined by the air-conditioning operation determination unit 152b and the package temperature calculated with the package model 145a.

The description here is made by using as an example the model in which the indoor space 6 is divided into three in the height direction, for example, as in FIG. 3.

The governing equations of fluid used in the CFD analysis may be, for example, the following equations (1) to (3).

$$[ Math . 1 ]$$

$$∇ \cdot u = 0 \qquad ( 1 )$$

$$[ Math . 2 ]$$

$$ρ ( \frac{\partial u}{\partial t} + ( u \cdot ∇ u ) ) = - ∇ p + ∇ \cdot ( μ ∇ u ) + ( ρ - {ρ}_{0} ) g \qquad ( 2 )$$

$$[ Math . 3 ]$$

$${C}_{p} ( \frac{\partial T}{\partial t} + u \cdot ∇ T ) = ∇ \cdot ( k ∇ T ) + Q \qquad ( 3 )$$

Here, V is a vector differential calculus operator, u is a three-dimensional velocity vector, t is time, p is pressure, ρ is density, μ is a viscosity coefficient, ρ₀ is reference density, g is gravitational acceleration, Cp is specific heat capacity at constant pressure, T is temperature, k is thermal conductivity, and Q is internal heat generation amount.

Equation (1) is a continuity equation expressing fluid mass conservation. Equation (2) is the incompressible Navier-Stokes equation expressing momentum conservation. Equation (3) is an energy equation. By solving Equations (1) to (3) with appropriate initial values and boundary conditions, temperature, airflow velocity, and other conditions can be calculated for each divided region. In this case, the air-conditioning apparatus operation data 144b and the sensor measurement data 144c are used as the initial values and boundary condition values for the CFD analysis.

Co-simulation calculation of the environmental distribution model 145b, the package model 145a, and the air-conditioning apparatus model 145c is carried out as follows. First, in the environmental distribution model 145b, the inside of the package 7 corresponding to the package placement 146 determined by the package placement determination unit 152a is excluded from calculation targets. On surfaces of a package region, a package temperature calculated with the package model 145a is given as a boundary condition, The region 6a without any package 7 in the indoor space 6 is regarded as a calculation target region of the environmental distribution model 145b. At the location of the air outlet of the air-conditioning apparatus 3 in the environmental distribution model 145b, an airflow volume and an outflowing air temperature of the air-conditioning apparatus 3 determined by the air-conditioning operation determination unit 152b are given.

### (Specific Example of Package Model 145a)

The package model 145a is a model calculating, for example, heat capacity of the package 7. and temperature of the package 7 that changes as the result of receiving or transferring heat between the package 7 and air around the package 7. The package model 145a may be expressed as, for example, the following equation (4).

$$[ Math . 4 ]$$

$$C \frac{{dT}_{b}}{dt} = KA ( {T}_{a} - {T}_{b} ) \qquad ( 4 )$$

Here, t is time, C is heat capacity of the package 7, Tb is package temperature, K is a heat transfer coefficient, A is surface area of the package 7, and Ta is surrounding air temperature. The heat capacity C of the package 7 is set based on the package management data 144a indicated in FIG. 6 and the package thermal characteristic table 142 indicated in FIG. 5. Specifically, the arithmetic device 15 obtains data of volume from the package management data 144a and data of volumetric heat capacity from the package thermal characteristic table 142. The heat capacity C can be obtained by multiplying volume and volumetric heat capacity. The arithmetic device 15 thus carries out this multiplication and calculates the heat capacity C. The surface area A of the package 7 is set based on the package management data 144a indicated in FIG. 6. Specifically, the arithmetic device 15 obtains data of volume from the package management data 144a and calculates the surface area A by performing a preset arithmetic operation such as differentiation of volume, As the surrounding air temperature Ta, an estimation result received from the environmental distribution model 145b is used. Alternatively, the sensor measurement data 144c may be used as the surrounding air temperature Ta.

### (Specific Example of Air-Conditioning Apparatus Model 145c)

The air-conditioning apparatus model 145c calculates temperature at the air outlet of the air-conditioning apparatus 3 and power of the air-conditioning apparatus 3 based on, for example, the temperature at the air inlet of the air-conditioning apparatus 3 and the air-conditioning operation state 147 and further calculates, by, for example, refrigeration cycle calculation, electric power necessary to output the calculated power.

As the temperature of the air inlet of the air-conditioning apparatus 3, a temperature in the region 6a calculated with the environmental distribution model 145b, or the sensor measurement data 144c may be used.

These models are merely an example, and other models and methods may be used.

### (Package Placement 146, Air-Conditioning Operation State 147, and Control Instruction 148)

The storage device 14 further stores the package placement 146, the air-conditioning operation state 147, and the control instruction 148. The package placement 146 specifies a placement of the package 7 in the indoor space 6 determined by the organizational optimization unit 152, which will be described later, of the arithmetic device 15. The air-conditioning operation state 147 indicates an operation state of the air-conditioning apparatus 3 determined by the organizational optimization unit 152, which will be described later, of the arithmetic device 15. The control instruction 148 indicates a control instruction generated by the control instruction conversion unit 153, which will he described later, of the arithmetic device 15.

### (Arithmetic Device 15)

The following describes the arithmetic device 15 provided in the air-conditioning control device 1. As illustrated in FIG. 2, the arithmetic device 15 includes a package thermal characteristic determination unit 151, the organizational optimization unit 152, and the control instruction conversion unit 153. The organizational optimization unit 152 includes the package placement determination unit 152a, the air-conditioning operation determination unit 152b, and the evaluation unit 152c.

### (Package Thermal Characteristic Determination Unit 151)

The package thermal characteristic determination unit 151 determines the thermal characteristic of each package 7 based on the package management data 144a indicated in FIG. 6 and accordingly sets a parameter of the package model 145a. The parameter is, for example, a parameter of Equation (4) described above. For example, when the parameter determined by the package thermal characteristic determination unit 151 is the heat capacity C of the package 7, the package thermal characteristic determination unit 151 obtains data of capacity from the package management data 144a and data of volumetric heat capacity from the package thermal characteristic table 142. The heat capacity C can be obtained by multiplying volume and volumetric heat capacity. The package thermal characteristic determination unit 151 thus carries out this multiplication and calculates the heat capacity C.

(Control Instruction Conversion Unit 153) The control instruction conversion unit 153 converts the air-conditioning operation state 147 determined by the organizational optimization unit 152 and stored in the storage device 14 into the control instruction 148 for instructing the air-conditioning apparatus 3.

### (Organizational Optimization Unit 152)

In the organizational optimization unit 152, first, the package placement determination unit 152a and the air-conditioning operation determination unit 152b respectively determine the package placement 146 and the air-conditioning operation state 147. Subsequently, the evaluation unit 152c performs calculations with the package model 145a, the air-conditioning apparatus model 145c, and the environmental distribution model 145b and consequently calculates evaluation values based on the estimation results obtained by the calculations. In the organizational optimization unit 152, the series of operations from determination of the package placement 146 and the air-conditioning operation state 147 to calculation of the evaluation values is regarded as one trial. The organizational optimization unit 152 repeats the trial a preset number of times by using the evaluation values while changing one or both of the package placement 146 and the air-conditioning operation state 147. For example, when the temperature in the region 6a calculated with the environmental distribution model 145b exceeds the maintenance temperature of the package 7 placed in the region 6a, the organizational optimization unit 152 increases the power of the air-conditioning apparatus 3 by, for example, performing any of the following operations:
(a) the package placement determination unit 152a redetermines the placement based on the maintenance temperature of the package 7;
(b) the air-conditioning operation determination unit 152b lowers the set temperature of the air-conditioning apparatus 3;
(c) the air-conditioning operation determination unit 152b increases the airflow volume of the air-conditioning apparatus 3;
(d) the air-conditioning operation determination unit 152b decreases the evaporating temperature in the refrigeration cycle of the air-conditioning apparatus 3.

As described above, the organizational optimization unit 152 repeats the trial until the trial count reaches the preset number of times. Subsequently, the organizational 15 optimization unit 152 determines the air-conditioning operation state 147 and the package placement 146 with the greatest evaluation values of the evaluation values stored in the storage device 14 as the optimum air-conditioning operation state and the optimum package placement.

### (Package Placement Determination Unit 152a)

The package placement determination unit 152a determines the package placement 146 based on the package management data 144a stored in the storage device 14. The determination of the package placement 146 is performed at the timing when a new package 7 is newly stored in the warehouse. A plurality of vacant regions are searched for an optimum region, thereby determining the package placement 146.

Alternatively, the package placement determination unit 152a may determine the placement of the package 7 consecutively at given intervals, so that the packages 7 having been stored in the indoor space 6 may be repositioned. The following specifically describes a method of determining the package placement 146.

It is assumed here that a plurality of the air-conditioning apparatus 3 are placed in the indoor space 6.

The package management data 144a indicated in FIG. 6 includes volume, maintenance temperature, warehouse entry date and time, and warehouse exit due date and time of each package 7. In the package management data 144a, each package 7 is assigned a package ID.

In the space characteristic information 141 indicated in FIG. 8, each air-conditioning apparatus 3 is assigned an air-conditioning apparatus ID, and each region 6a provided by dividing the indoor space 6 into smaller spaces is assigned a region ID. As indicated in FIG. 8, the region ID of each region 6a is associated with an air-conditioning apparatus ID of one air-conditioning apparatus 3 for controlling the heating energy environment of the region 6a. When a package 7 is placed in the region 6a, the region ID of the region 6a is associated with the package ID of the package 7.

Additionally, attribute values are preset for each region 6a. In the example in FIG. 8, work efficiency, temperature consistency, and airflow reach level are indicated as an example of the attribute values. As described above, the work efficiency may be set to, for example, 0 when the work efficiency is low, and 1 when the work efficiency is high, based on information about accessibility from the entrance of the indoor space 6. As described above, the temperature consistency may be set to, for example, 0 for a region with large temperature changes and 10 for a region with small temperature changes, based on, for example, information such as the distance from the entrance, at which relatively large changes in temperature are expected due to inflow of the outside air, or the sensor measurement data 144c previously obtained. As described above, the airflow reach level may be set to, for example, 100 for a region with high airflow reachability and 1 for a region with low airflow reachability, based on information such as the distance from the air outlet of the air-conditioning apparatus 3.

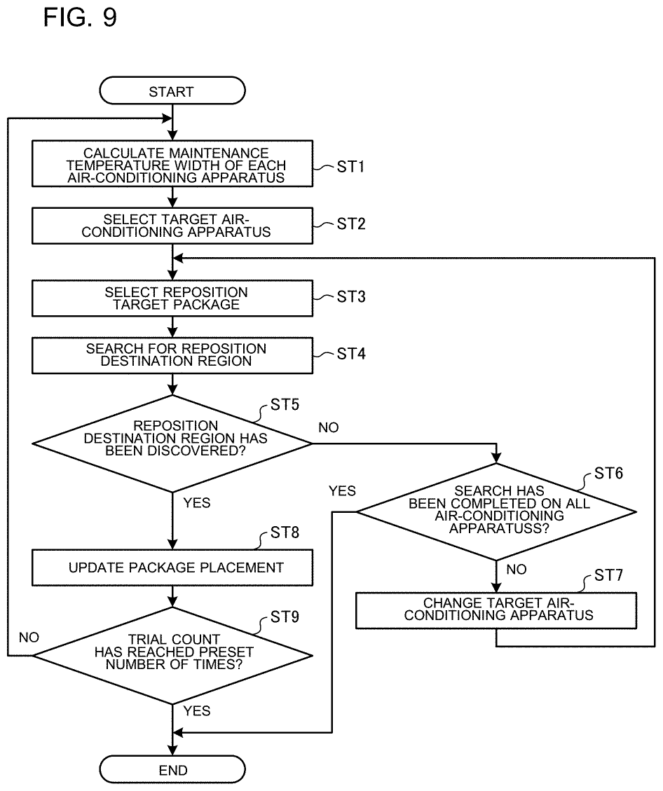

Regarding the method of determining placement of the package 7 with the package placement determination unit 152a, first, a flow for determining package placement in consideration of energy saving will be described with reference to FIG. 9, FIG. 9 is a flowchart illustrating a flow of a process performed by the package placement determination unit 152a of the air-conditioning control device 1 according to Embodiment 1.

In step ST1, the package placement determination unit 152a calculates a maintenance temperature width of each air-conditioning apparatus 3, To be specific, first, the package placement determination unit 152a refers to the space characteristic information 141 in FIG. 8 and extracts package IDs of the packages 7 placed in the regions 6a having the same air-conditioning apparatus ID among the regions 6a of the indoor space 6. Next, the package placement determination unit 152a refers to the package management data 144a in FIG. 6, extracts the highest and lowest temperatures from the maintenance temperatures of these packages 7, and calculates the difference between the highest and lowest temperatures as a maintenance temperature width.

The package placement determination unit 152a performs this operation for the individual air-conditioning apparatus IDs of the air-conditioning apparatus 3. In the example in FIG. 6, region IDs of the regions 6a having an air-conditioning apparatus ID “A001” are “S001”, “S002”, and “S003”. Package Ds of the packages 7 placed in these regions 6a are “B001”, “6002”, and “6003”. Based on the highest temperature of “−20 degrees C.” and the lowest temperature of “−24 degrees C” of the maintenance temperatures of these packages 7, the package placement determination unit 152a obtains “4 degrees C.” as the maintenance temperature width of the air-conditioning apparatus ID “A001”. The maintenance temperature range in this case is “from −24 degrees C. to −20 degrees C”. The package placement determination unit 152a performs the same operation and accordingly obtains “0 degrees C.” as the maintenance temperature width of the air-conditioning apparatus ID “A002”. The maintenance temperature range in this case is “−24 degrees C”. In this manner, the package placement determination unit 152a calculates a maintenance temperature width of each air-conditioning apparatus 3.

In step ST2, the package placement determination unit 152a compares the air-conditioning apparatus 3 with respect to the maintenance temperature width and selects the air-conditioning apparatus 3 with the widest maintenance temperature width as a target air-conditioning apparatus. Here, the target air-conditioning apparatus is, for example, the air-conditioning apparatus 3 of the air-conditioning apparatus ID “A001”.

In step ST3, the package placement determination unit 152a selects as a reposition target package one package 7 of the lowest maintenance temperature from the packages 7 associated with the target air-conditioning apparatus. In this case, the package 7 of the lowest maintenance temperature of the packages 7 associated with the air-conditioning apparatus 3 of the air-conditioning apparatus ID “A001” is the package 7 of the package ID “B003”. As a result, the package 7 of the package ID “B003” is determined to be a reposition target package.

In step ST4, the package placement determination unit 152a searches for a reposition destination region of the reposition target package. Specifically, the package placement determination unit 152a first searches for the air-conditioning apparatus 3 of a maintenance temperature range including the maintenance temperature of the reposition target package. Next, the package placement determination unit 152a searches the regions 6a associated with the discovered air-conditioning apparatus 3 for the region 6a having a vacant region of a volume equal to or larger than the capacity of the reposition target package and determines the discovered region 6a to be a reposition destination region. When there is no vacant region, the package placement determination unit 152a searches for the package 7 that can be replaced with the reposition target package. Specifically, the package placement determination unit 152a searches for the packages 7 almost equal in volume to the reposition target package. Next, the package placement determination unit 152a searches these packages 7 for the package 7 of a maintenance temperature included in the maintenance temperature range of the air-conditioning apparatus 3 currently associated with the reposition target package. The package placement determination unit 152a determines the region 6a currently storing the discovered package 7 to be the reposition destination region of the reposition target package.

In step ST5, the package placement determination unit 152a determines whether a reposition destination region of the reposition target package has been discovered. When a reposition destination region has been discovered, the process proceeds to step ST8; when no reposition destination region has been discovered, the process proceeds to step ST6.

In step ST6, the package placement determination unit 152a determines whether the search for a region destination region has been completed on all the air-conditioning apparatus 3. When there is any unselected air-conditioning apparatus 3, the process proceeds to step ST7; when the search has been completed on all the air-conditioning apparatus 3, the process in FIG. 9 ends.

In step ST7, the package placement determination unit 152a selects the air-conditioning apparatus 3 of the second widest maintenance temperature width after the air-conditioning apparatus 3 selected in step ST2 and returns to the operation in step ST3.

In step ST8, the package placement determination unit 152a updates the package placement 146. Specifically, when the reposition destination region determined in step ST4 is a vacant region in the space characteristic information 141 in FIG. 8, the package placement determination unit 152a records the package ID of the reposition target package in association with the reposition destination region. The package placement determination unit 152a also deletes the package ID of the reposition target package from the region currently storing the reposition target package and changes the region to a vacant region. By contrast, when another package 7 is currently placed in the reposition destination region, the package placement determination unit 152a switches the package Ds between the reposition destination region and the region currently storing the reposition target package.

In step ST 9, the package placement determination unit 152a determines whether the trial count has reached a preset number of times. When the trial count has not reached the preset number of times, the process returns to the operation in step ST1; when the trial count has reached the preset number of times, the process in FIG. 9 ends.

As described above, by performing the process in FIG. 9, the maintenance temperature width of each air-conditioning apparatus 3 decreases. As a result, for example, the packages 7 of relatively low maintenance temperatures are collected in the regions 6a associated with the same air-conditioning apparatus 3, and thus, the output of the air-conditioning apparatus 3 in other regions 6a can be reduced. This can achieve energy saving.

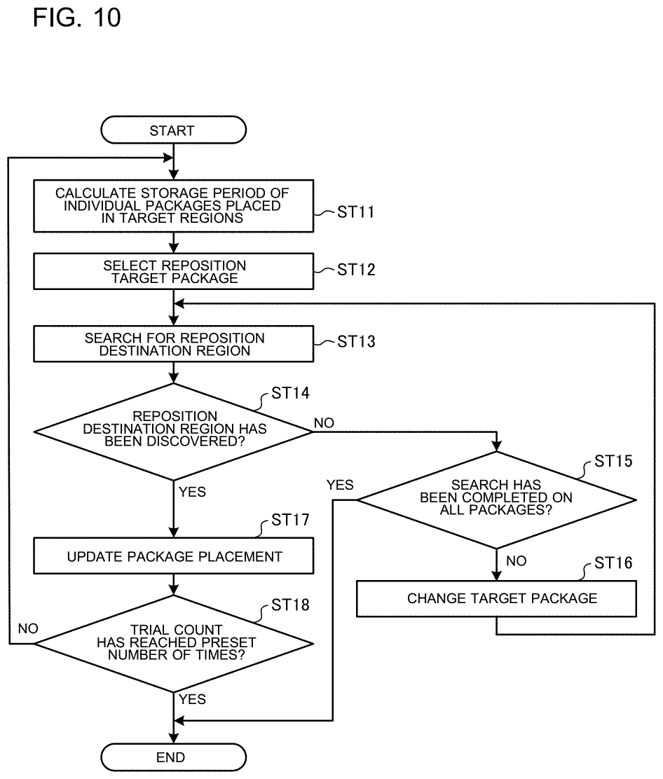

The following describes a flow in the case in which the package placement 146 is determined in the regions 6a associated with the same air-conditioning apparatus 3 in consideration of work efficiency, with reference to FIG. 10. FIG. 10 is a flowchart illustrating a flow of a process performed by the package placement determination unit 152a of the air-conditioning control device 1 according to Embodiment 1.

In step ST11, the package placement determination unit 152a selects the regions 6a associated with the same air-conditioning apparatus 3 from the plurality of regions 6a and determines the selected region 6a to be the target regions 6a. The package placement determination unit 152a refers to the package management data 144a in FIG. 6 with respect to the target regions 6a and calculates a remaining storage period of each of the packages 7 placed in the target regions 6a based on the present date and time and the warehouse exit due date and time.

In step ST12, the package placement determination unit 152a selects the package 7 with the shortest remaining storage period as a reposition target package,

In step ST13, the package placement determination unit 152a searches for a reposition destination region of the reposition target package. Specifically, the package placement determination unit 152a searches all the target regions 6a successively in descending order of work efficiency. When there is a vacant region of a volume equal to or larger than the reposition target package, the package placement determination unit 152a determines the region 6a to be a reposition destination region. When all the target regions do not include any vacant region, the package placement determination unit 152a searches for the package 7 that can be replaced with the reposition target package. Specifically, the package placement determination unit 152a searches the packages 7 almost equal in volume to the reposition target package in descending order of the length of storage period. When one package 7 has a storage period longer than the reposition target package and is placed in the region 6a of high work efficiency, the region is determined to be a reposition destination region.

In step ST14, the package placement determination unit 152a determines whether a reposition destination region has been discovered. When a reposition destination region has been discovered, the process proceeds to step ST17; when no reposition destination region has been discovered, the process proceeds to step ST15.

In step ST15, the package placement determination unit 152a determines whether the search has been completed on all the packages 7 in the target regions; when there is any unselected package 7, the process proceeds to step ST16; when the search has been completed on all the air-conditioning apparatus 3, the process ends.

In step ST16, the package placement determination unit 152a selects the package 7 of the second shortest storage period after the package 7 selected in step ST12 and determines the selected package 7 to be a new target package. The process subsequently returns to step ST13.

In step ST17 the package placement determination unit 152a updates the package placement 146. Specifically, when the reposition destination region is a vacant region, the package placement determination unit 152a records the package ID of the reposition target package in association with the reposition destination region in the space characteristic information 141 in FIG. 8. The package placement determination unit 152a also deletes the package ID of the reposition target package from the region currently storing the reposition target package and changes the region to a vacant region. By contrast, when the package 7 is placed in the reposition destination region, the package placement determination unit 152a switches the package IDs between the reposition destination region and the region 6a currently storing the reposition target package.

In step ST18, the package placement determination unit 152a determines whether the trial count has reached a preset number of times. When the trial count has not reached the preset number of times, the process returns to the operation in step ST11; when the trial count has reached the preset number of times, the flow in FIG. 10 ends.

As described above, by performing the process in FIG. 10, the package 7 with a relatively short remaining storage period is moved to the region 6a of high work efficiency, and as a result, the operation of taking packages out of the warehouse n be easily carried out.

The methods illustrated in FIGS. 9 and 10 of determining placement with the use of indicators of energy-saving and work efficiency are merely examples. As the indicator used to determine placement, as well as the indicators described above, for example, time period elapsed since the warehouse entry date and time of each package 7, heat capacity of the package 7, airflow reach level of each region 6a, or temperature consistency of each region 6a may be used.

For example, when the package placement determination unit 152a uses time elapsed since the warehouse entry date and time of each package 7 as the indicator to determine placement of the packages 7, the packages 7 with relatively short times elapsed since their warehouse entry date and time are collectively placed. Additionally, the package 7 having been stored for a given time since its warehouse entry date and time is moved to another region 6a, Because the cooling load for the packages 7 shortly after being stored in the warehouse is expected to be relatively large, by collectively placing these packages 7. only the output of the air-conditioning apparatus 3 in the corresponding regions 6a needs to be increased; as a result, the power of the air-conditioning apparatus 3 in the other regions 6a can be suppressed.

When the package placement determination unit 152a uses heat capacity of the package 7 as the indicator to determine placement of the packages 7, it is expected that the packages 7 of relatively small heat capacity is largely affected by changes in temperature in the surrounding environment. Hence, the packages 7 of relatively small heat capacity are collected in the regions 6a with small temperature changes, such as the regions 68 far from the entrance. With this configuration, the quality of the packages 7 can be maintained.

The following describes the case in which the package placement determination unit 152a uses airflow reach level of each region 6a as the indicator to determine placement of the packages 7. if the packages 7 are collectively placed in only the regions 6a of relatively high airflow reach levels, these packages 7 act as blockages, so that air flow is blocked. This leads to a concern that air flow fails to reach the other regions 6a. Hence, when airflow reach level is used as the indicator to determine placement of the packages 7, the package placement determination unit 152a do not collectively place the packages 7 in the regions 6a of relatively high airflow reach levels. Based on airflow reach level, the package placement determination unit 152a evenly places the packages 7 so that air flows reach all the regions 6a. This configuration can eliminate the existence of the regions 6a that air flows do not reach, Specifically, the packages 7 can be prevented from being collected in only the regions 6a of relatively high airflow reach levels by, for example, presetting an upper limit of the number of the packages 7 on the regions 6a of relatively high airflow reach levels.

The following describes another example of the case in which airflow reach level of each region 6a is used as the indicator to determine placement of the packages 7, The package placement determination unit 152a places the packages 7 of relatively low maintenance temperatures in the regions 6a of relatively high airflow reach levels and the packages 7 of relatively high maintenance temperatures in the regions 6a of relatively low airflow reach levels. By using the distribution of airflow reach level in the regions 6a covered by the same air-conditioning apparatus 3, it is possible to suppress the air conditioning power of each air-conditioning apparatus 3.

The package placement determination unit 152a may determine the package placement 146 based on the package temperature of the package 7 calculated by the evaluation unit 152c with the package model 145a. Alternatively, the package placement determination unit 152a may determine the package placement 146 based on the temperature of each region 6a of the indoor space 6 calculated with the environmental distribution model 145b. Alternatively, the package placement determination unit 152a may determine the package placement 146 based on the electricity consumption of the air-conditioning apparatus 3 calculated with the air-conditioning apparatus model 145c. In this case, the package placement determination unit 152a determines the package placement 146 based on one of the package temperature of the package 7, the temperature in each region 6a of the indoor space 6, and the electricity consumption of the air-conditioning apparatus 3, or any combination thereof.

The indicators described as examples may be used in a combined manner, for example, such that evaluation values of the indicators are set in numerical values and added together.

### (Air-Conditioning Operation Determination Unit 152b)

The air-conditioning operation determination unit 152b determines the air-conditioning operation state 147 of the air-conditioning apparatus 3 based on the package placement 146 determined by the package placement determination unit 152a. The air-conditioning operation determination unit 152b determines the air-conditioning operation state 147 of the air-conditioning apparatus 3 including either one of the set temperature of the air-conditioning apparatus 3 and the evaporating temperature in the refrigeration cycle set on the air-conditioning apparatus 3, based on the package placement 146 determined by the package placement determination unit 152a. The air-conditioning operation state may further include, for example, set humidity, airflow direction, airflow volume, and airflow velocity. In one case, the package placement determination unit 152a may determine the package placement 146 of the packages 7, with regard to, for example, the maintenance temperature of the package 7 or the time period elapsed since the warehouse entry date and time of the package 7, to collect the packages 7 of heavy or light loads. In this case, the air-conditioning operation determination unit 152b sets the set temperature or controls the evaporating temperature in the refrigeration cycle such that the temperatures in the regions 6a associated with each air-conditioning apparatus 3 do not exceed the maintenance temperatures of the packages 7 placed in the regions 6a. With this configuration, in the regions 6a collectively storing the packages 7 of relatively light loads, the set temperature or the evaporating temperature can be set with relaxed loads, and as a result, energy for air conditioning can be reduced. The air-conditioning operation determination unit 152b may determine the air-conditioning operation state 147 of the air-conditioning apparatus 3 based on the package placement 146 and the package temperature of the package 7 calculated with the package model 145a.

The air-conditioning operation determination unit 152b may determine the air-conditioning operation state 147 based on the package temperature of the package 7 calculated by the evaluation unit 152c with the package model 145a, Alternatively, the air-conditioning operation determination unit 152b may determine the air-conditioning operation state 147 based on the temperature of each region 6a of the indoor space 6 calculated with the environmental distribution model 145b. Alternatively, the air-conditioning operation determination unit 152b may determine the air-conditioning operation state 147 based on the electricity consumption of the air-conditioning apparatus 3 calculated with the air-conditioning apparatus model 145c, In this case, the package placement determination unit 152a determines the air-conditioning operation state 147 based on one of the package temperature of the package 7, the temperature in each region 6a of the indoor space 6, and the electricity consumption of the air-conditioning apparatus 3, or any combination thereof.

### (Evaluation Unit 152c)

The evaluation unit 152c receives an input of the package placement determined by the package placement determination unit 152a and an input of the air-conditioning operation determined by the air-conditioning operation determination unit 152b and accordingly performs calculations with the environmental distribution model 145b, the package model 145a, and the air-conditioning apparatus model 145c, As a result, the evaluation unit 152c can obtain the temperature in each region 6a of the indoor space 6, the temperature of each package 7, and the electricity consumption of the air-conditioning apparatus 3. For example, to achieve a most energy-efficient operation while the maintenance temperatures of the packages 7 are satisfied, the limiting condition is whether the surrounding temperature of each package 7 calculated with the environmental distribution model 145b satisfies the maintenance temperature of the package 7. When the limiting condition is satisfied, the evaluation unit 152c stores the electricity consumption as an evaluation value. As the limiting condition, for example, whether the number of times the package 7 has been moved is equal to or fewer than a preset number of times may be used as well.

As described above, the air-conditioning control device 1 of Embodiment 1 has the package model 145a, the air-conditioning apparatus model 145c, and the environmental distribution model 145b. With these models, the air-conditioning control device 1 can calculate as evaluation values the temperature in each region 6a of the indoor space 6, the temperature of each package 7, and the electricity consumption of the air-conditioning apparatus 3 by using the air-conditioning apparatus operation data 144b and the sensor measurement data 144c. Further, the air-conditioning control device 1 determines whether the limiting condition is achievable and calculates the evaluation values multiple times while changing the package placement 146 and the air-conditioning operation state 147, so that the air-conditioning control device 1 can determine the package placement and air-conditioning operation state with which the limiting condition is satisfied with greatest evaluation values. As a result, Embodiment 1 can optimize both package placement and air conditioning control; while maintaining the surrounding temperature of the package 7 within the temperature and humidity ranges determined by the maintenance temperature and also securing work efficiency in the indoor space 6, energy-saving air conditioning control can be realized.

### Reference Signs List

1: air-conditioning control device, 2: package management system, 3: air-conditioning apparatus, 4: sensor, 5: control network, 6: indoor space, 6a: region, 7: package, 11: receiver device, 12: transmitter device, 13: display device, 14: storage device, 15: arithmetic device, 31: outdoor unit, 32: indoor unit, 33: controller, 141: space characteristic information, 142: package thermal characteristic table, 143: operational condition, 144: result/plan data, 144a: package management data, 144b: air-conditioning apparatus operation data, 144c: sensor measurement data, 145: model, 145a: package model, 145b: environmental distribution model, 145c: air-conditioning apparatus model, 146: package placement, 147: air-conditioning operation state, 148: control instruction, 151: package thermal characteristic determination unit, 152: organizational optimization unit, 152a: package placement determination unit, 152b: air conditioning operation determination unit, 152c: evaluation unit, 153: control instruction conversion unit

1. An air-conditioning control device configured to control an air-conditioning apparatus conditioning air in an indoor space where a package is stored, the air-conditioning control device comprising:
a receiver device configured to receive package management data including item information of the package, air-conditioning apparatus operation data including a set temperature of the air-conditioning apparatus, and sensor measurement data including a temperature in the indoor space, the temperature in the indoor space being measured by a sensor installed in the indoor space;
air-conditioning operation determination circuitry configured to determine an air-conditioning operation state of the air-conditioning apparatus based on a package placement of the package, the air-conditioning operation state including either one of the set temperature of the air-conditioning apparatus and an evaporating temperature in a refrigeration cycle that is set on the air-conditioning apparatus;
a memory configured to store a package model for estimating a package temperature of the package based on the package management data, an environmental distribution model for estimating the temperature in the indoor space based on the package placement of the package, the air-conditioning operation state determined by the air-conditioning operation determination unit, and the air-conditioning apparatus operation data and the sensor measurement data that are received by the receiver device, and an air-conditioning apparatus model for estimating electricity consumption of the air-conditioning apparatus based on the air-conditioning operation state determined by the air-conditioning operation determination unit; and
evaluation circuitry configured to receive inputs of the package management data, the air-conditioning apparatus operation data, and the sensor measurement data that are received by the receiver device, an input of the package placement, and an input of the air-conditioning operation state of the air-conditioning apparatus determined by the air-conditioning operation determination circuitry unit, calculate as an evaluation value at least one of the package temperature, the temperature in the indoor space, and the electricity consumption of the air-conditioning apparatus by using the package model, the environmental distribution model, and the air-conditioning apparatus model that are stored in the memory, and update the air-conditioning operation state and the package placement,

2. The air-conditioning control device of claim 1, wherein
the package management data includes, for an individual piece of identification information of the package,
a maintenance temperature of the package,
the item information of the package, the item information indicating a content of the package, and
at least one of a warehouse entry date and time of the package and a warehouse exit due date and time of the package.

3. The air-conditioning control device of claim 1, wherein
the package model is configured to estimate the package temperature by using a heat capacity of the package, the heat capacity being calculated based on the item information of the package included in the package management data.

4. The air-conditioning control device of claim 1, wherein
the evaluation circuitry is configured to cause on a given cycle the package model and the environmental distribution model to mutually use an estimation result calculated with the package model and an estimation result calculated with the environmental distribution model such that the package temperature calculated by the evaluation circuitry with the package model is used as an input to the environmental distribution model, and
the temperature at each point of the plurality of points in the indoor space calculated by the evaluation circuitry with the environmental distribution model is used as an input to the package model.

5. The air-conditioning control device of claim 1, wherein
the evaluation circuitry is configured to cause on a given cycle the environmental distribution model and the air-conditioning apparatus model to mutually use an estimation result calculated with the environmental distribution model and an estimation result calculated with the air-conditioning apparatus model such that
of the temperature in the indoor space calculated by the evaluation circuitry with the environmental distribution model, a temperature at a location of an air inlet of the air-conditioning apparatus is used as an input to the air-conditioning apparatus model configured to calculate a temperature of an air outlet of the air-conditioning apparatus, and
the temperature of the air outlet of the air-conditioning apparatus calculated by the evaluation circuitry with the air-conditioning apparatus model is used as an input to the environmental distribution model configured to calculate the temperature at the location of the air inlet of the air-conditioning apparatus.

6. The air-conditioning control device of claim 12, wherein
the package placement determination circuitry is configured to determine the package placement based on any of a heat capacity of the package, the heat capacity being calculated based on the item information of the package included in the package management data, a time period elapsed since the warehouse entry date and time of the package, and a remaining storage period until a warehouse exit due date and time of the package.

7. The air-conditioning control device of claim 12, wherein
the memory is configured to store space characteristic information including at least one of a work efficiency, a temperature consistency, and an airflow reach level of individual regions determined by dividing the indoor space, and
the package placement determination circuitry is configured to determine the package placement of the package based on at least one of the work efficiency, the temperature consistency, and the airflow reach level of the individual regions included in the space characteristic information.

8. The air-conditioning control device of claim 1, wherein
the air-conditioning operation determination circuitry is configured to determine an operation state of the air-conditioning apparatus based on the package placement and the package temperature.

9. The air-conditioning control device of claim 12, wherein
the package placement determination circuitry is configured to determine the package placement based on any one of the package temperature of the package calculated by the evaluation circuitry with the package model, the temperature in the indoor space calculated by the evaluation circuitry with the environmental distribution model, and the electricity consumption of the air-conditioning apparatus calculated by the evaluation circuitry with the air-conditioning apparatus model, or any combination of the package temperature, the temperature at each point of the plurality of points, and the electricity consumption.

10. The air-conditioning control device of claim 1, wherein
the air-conditioning operation determination circuitry is configured to determine the air-conditioning operation state of the air-conditioning apparatus based on any one of the package temperature of the package calculated by the evaluation circuitry with the package model, the temperature in the indoor space calculated by the evaluation circuitry with the environmental distribution model, and the electricity consumption of the air-conditioning apparatus calculated by the evaluation circuitry with the air-conditioning apparatus model, or any combination of the package temperature, the temperature in the indoor space, and the electricity consumption.

11. The air-conditioning control device of claim 1, wherein the evaluation circuitry is configured to, while changing based on the calculated evaluation value one or both of the package placement and the air-conditioning operation state determined by the air-conditioning operation determination circuitry, repeatedly calculate the evaluation value a preset number of times, and update the air-conditioning operation state and the package placement when the evaluation value is a greatest value of evaluation values of the preset number of times to be the air-conditioning operation state and the package placement.

12. The air-conditioning control device of claim 11, further comprising:
package placement determination circuitry configured to determine a package placement of the package based on the package management data received by the receiver device;
control instruction conversion circuitry configured to convert the air-conditioning operation state determined by the evaluation circuitry into a control instruction to be provided for the air-conditioning apparatus;
a transmitter device configured to transmit the control instruction to the air-conditioning apparatus; and
a display configured to display the package placement updated by the evaluation circuitry.
